(19) United States
(12) Patent Application Publication
(10) Pub. No.: US 2024/0373898 A1
(43) Pub. Date: Nov. 14, 2024

(54) NON-CONTACT, CLOSED LOOP FEEDBACK FOR DEHYDRATOR CONTROL

(71) Applicant: Heartland Ag Tech, Inc., Hancock, WI (US)

(72) Inventors: Russell Sanders, Minnetonka, MN (US); Jeremie Pavelski, Wisconsin Rapids, WI (US); Blair Miller, Plover, WI (US); Zeb Zimmer, Minneapolis, MN (US)

(21) Appl. No.: 18/651,976

(22) Filed: May 1, 2024

Related U.S. Application Data
(60) Provisional application No. 63/465,393, filed on May 10, 2023.

(51) Int. Cl. A23P 30/00; G06V 10/70

(52) U.S. Cl. CPC A23P 30/00; G06V 10/70

(57) ABSTRACT

A non-contact, closed-loop system for dehydrator control includes a dehydrator, a sensor configured to measure distribution of a product along a surface of the dehydrator, a processor, and a memory. The memory, includes instructions stored thereon, which, when executed by the processor, cause the system to: measure the distribution of a product along the surface of the dehydrator; determine differences between the distribution of the product along the surface of the dehydrator and a predetermined distribution of the product along the surface of the dehydrator; and adjust a control parameter of the non-contact, closed-loop system in response to the determined differences to reduce the differences and control the distribution of the product along the surface of the dehydrator when the dehydrator operates.

### CROSS-REFERENCE TO RELATED APPLICATIONS

The present application claims the benefit of U.S. Provisional Patent Application No. 63/465,393, filed on May 10, 2023, the entire contents of which are hereby incorporated herein by reference.

### TECHNICAL FIELD

This disclosure relates to control systems and, more particularly, to structures and methods for effectuating control of uniformity of a product, for example, drum dryer mash.

### BACKGROUND

Dehydrators such as drum dryers are manually operated devices used to produce mash. As can be appreciated, operators of such devices strive to maintain mash uniformity. However, even with a skilled operator, manual operation of drum dryers can be quite challenging. Indeed, the operator's skill, knowledge, and attentiveness are major factors in determining the uniformity of the mash. If an operator does not have sufficient skill, knowledge, and attentiveness for operating such drum dryers, problems can very quickly occur. For instance, some such problems may be uncontrolled mash distribution, high sheet variability off the drum, wasted mash that falls off before being converted to a sheet, excess wear on equipment, and employee frustration, among others.

### SUMMARY

To overcome the foregoing challenges, the present disclosure describes systems and methods for controlling dehydrators such as drum dryers to produce uniform mash consistently and efficiently.

In an aspect of the present disclosure, a non-contact, closed-loop system for dehydrator control includes a dehydrator, a sensor configured to measure a distribution of a product along a surface of the dehydrator, a processor, and a memory. The memory includes instructions stored thereon, which, when executed by the processor, cause the non-contact, closed-loop system to: measure the distribution of the product along the surface of the dehydrator; determine differences between the distribution of the product along the surface of the dehydrator and a predetermined distribution of the product along the surface of the dehydrator; and adjust a control parameter of the non-contact, closed-loop system in response to the determined differences to reduce the differences and control the distribution of the product along the surface of the dehydrator when the dehydrator operates.

In another aspect of the present disclosure, the control parameter may include a drum speed, a scraping sequence, a mash ribbon speed, a drum pressure, a feed rate, a scraper speed, an additive flow rate, a mash supplemental water flow, a water flow, a doctor blade age, a roller-to-drum gapping, a mash rate, mash temperature, mash stickiness, mash chunkiness, and/or additive concentration.

In yet another aspect of the present disclosure, the control parameter of the non-contact, closed-loop system may be adjusted by actuating an actuator configured to operate one or more components of the non-contact, closed-loop system including one or more components of at least one of a cooker, a masher, or the dehydrator. In aspects, this may be, for example, a change in operation temperature (e.g., of the cooker to control temperature of the mash), a change in speed (e.g., actuation speed of the masher to control mash rate and/or rotation of the dehydrator to control dehydration rate), and/or a change in operation time/interval of any of these components or subcomponents thereof, etc., or combinations thereof.

In yet another aspect of the present disclosure, the control parameter of the non-contact, closed-loop system may be adjusted by changing the speed of a variable speed motor that controls an angular velocity of the dehydrator.

In a further aspect of the present disclosure, the instructions, when executed by the processor, may further cause the non-contact, closed-loop system to determine one or more parameters of the product based on the measured distribution of the product along the surface of the dehydrator. The one or more parameters may include at least one of a sheet uniformity, a sheet stability, a sheet property, a weight belt volume, a process yield, or a drum setting controllability. The non-contact, closed-loop system determines, based on the one or more parameters, differences between the distribution of the product along the surface of the dehydrator and the predetermined distribution of the product along the surface of the dehydrator.

In yet another aspect of the present disclosure, the sensor may include an image sensor configured to capture an image of the product in the dehydrator. When measuring the distribution of the product, the instructions, when executed by the processor, further cause the non-contact, closed-loop system to access a captured image.

In a further aspect of the present disclosure, when determining differences between the distribution of the product along the surface of the dehydrator and the predetermined distribution of the product along the surface of the dehydrator, the instructions, when executed by the processor, may further cause the non-contact, closed-loop system to determine a metric indicating an adequacy of the distribution of the product in the dehydrator.

In a further aspect of the present disclosure, when determining the metric, the instructions, when executed by the processor, may further cause the non-contact, closed-loop system to: identify, by a machine vision model one or more locations of the product in the dehydrator based on the image; and determine by a machine learning model the metric indicating an adequacy of a distribution of the product in the dehydrator based on the one or more identified locations of the product across the dehydrator.

In yet another aspect of the present disclosure, the sensor may include a pressure sensor, a flow meter, LIDAR, radar, ultrasonic sensing, a feeler gauge, and/or a limit switch.

In a further aspect of the present disclosure, the closed-loop system may further include an analytics engine configured to perform the determinations. The analytics engine may optionally include at least one of basic logic or a machine learning model. The machine learning model may be based on a deep learning network, a classical machine learning model, or combinations thereof.

In an aspect of the present disclosure, a computer-implemented method for non-contact, closed-loop dehydrator control is presented. The computer-implemented method includes measuring, by a sensor, a distribution of a product along a surface of the dehydrator of a non-contact, closed-loop system including at least one of a cooker, a masher, or the dehydrator; determining differences between the distribution of the product along the surface of the dehydrator and a predetermined distribution of the product along the surface of the dehydrator; and adjusting a control parameter of the non-contact, closed-loop system in response to the determined differences to reduce the differences and control the distribution of the product along the surface of the dehydrator when the dehydrator operates.

In yet a further aspect of the present disclosure, the product may include mash.

In yet another aspect of the present disclosure, the control parameter may include a drum speed, a scraping sequence, a mash ribbon speed, a drum pressure, a feed rate, a scraper speed, an additive flow rate, a mash supplemental water flow, a water flow, a doctor blade age, a roller-to-drum gapping, a mash rate, mash temperature, mash stickiness, mash chunkiness, and/or additive concentration.

In a further aspect of the present disclosure, the control parameter of the dehydrator may be adjusted by actuating an actuator configured to operate one or more components of the dehydrator and/or changing the speed of a variable speed motor that controls an angular velocity of the dehydrator.

In yet a further aspect of the present disclosure, the method may further include determining one or more parameters of the product based on the measured distribution of the product along the surface of the dehydrator. The one or more parameters may include at least one of a sheet uniformity, a sheet stability, a sheet property, a weight belt volume, a process yield, or a drum setting controllability. The determining the differences between the distribution of the product along an inner surface of the dehydrator and the predetermined distribution of the product along the inner surface of the dehydrator, may be further based on the one or more parameters.

In yet a further aspect of the present disclosure, the sensor may include an image sensor configured to capture an image of the product in the dehydrator. Measuring the distribution of the product may include accessing a captured image.

In yet another aspect of the present disclosure, when determining differences between the distribution of the product along the surface of the dehydrator and the predetermined distribution of the product along the surface of the dehydrator, may further include determining a metric indicating an adequacy of the distribution of the product in the dehydrator.

In a further aspect of the present disclosure, the method may further include identifying, by a machine vision model one or more locations of the product in the dehydrator based on the image; and determining by a machine learning model the metric indicating an adequacy of a distribution of the product in the dehydrator based on the one or more identified locations of the product across the dehydrator.

In yet a further aspect of the present disclosure, the sensor may include a pressure sensor, a flow meter, LIDAR, radar, ultrasonic sensing, a feeler gauge, and/or a limit switch.

In an aspect of the present disclosure, a non-transitory computer readable medium storing instructions for a computer-implemented method for drum dryer control in a non-contact, closed-loop system is presented. The computer-implemented method includes measuring, by a sensor, a distribution of a product along a surface of a drum dryer of the non-contact, closed-loop system; determining differences between the distribution of the product along the surface of the drum dryer and a predetermined distribution of the product along the surface of the drum dryer; and adjusting a control parameter of a component of the non-contact, closed-loop system in response to the determined differences to reduce the differences and control the distribution of the product along the surface of the drum dryer when the drum dryer operates.

Other aspects, features, and advantages will be apparent from the description, the drawings, and the claims that follow.

### BRIEF DESCRIPTION OF DRAWINGS

The accompanying drawings, which are incorporated in and constitute a part of this specification, illustrate aspects of the disclosure and, together with a general description of the disclosure given above and the detailed description given below, explain the principles of this disclosure, wherein:

FIG. 1 is a diagram illustrating a non-contact, closed-loop system in accordance with the principles of this disclosure;

FIG. 2 is a block diagram of a controller configured for use with the system of FIG. 1;

FIG. 3 is a diagram illustrating a machine learning model configured for use with the system of FIG. 1;

FIG. 4 illustrates an exemplary block diagram of a drum dryer operation configured for use with the system of FIG. 1;

FIG. 5 illustrates an exemplary flow chart of a drum dryer operation for controlling mash distribution in accordance with the system of FIG. 1;

FIG. 6 is a view illustrating a drum dryer system having starved top roller edges;

FIG. 7 is a view illustrating a drum dryer system having a drum with excess mash under the drum;

FIG. 8 is a view illustrating a drum dryer system having a starved drum where mash is not sticking;

FIG. 9 is a view illustrating a drum dryer system having a stuffed gap between a pair of rollers;

FIG. 10 is a view illustrating a drum dryer system having a mash imbalance on left and right sides of a roller;

FIG. 11 is a view illustrating a drum dryer system having a roller with mash cramming both sides of the roller;

FIG. 12 is a view illustrating a drum dryer system having a roller with mash cramming on one side of the roller;

FIG. 13 is a view illustrating a resultant mash processing defect when an operator is not attentive during drum operation of a drum dryer system;

FIG. 14 is a view illustrating a drum dryer system having stuffed rollers;

FIG. 15 is a view illustrating a drum dryer system having sheet debris buildup;

FIG. 16 is a view illustrating a drum dryer system having roller edge starvation;

FIG. 17 is a view illustrating a resultant mash processing defect when a drum of a drum dryer system is straight scraped; and

FIGS. 18 and 19 illustrate exemplary flow paths along a floor plan of a food processing plant in accordance with the system of FIG. 1.

### DETAILED DESCRIPTION

This disclosure relates to control systems and, more particularly, to structures and methods for effectuating uniformity control of a product.

Aspects of the disclosed systems and methods for effectuating control of the uniformity of a product, for example, drum dryer mash, are described in detail with reference to the drawings, in which like reference numerals designate identical or corresponding elements in each of the several views. Directional terms such as top, bottom, and the like are used simply for convenience of description and are not intended to limit the disclosure attached hereto.

In the following description, well-known functions or constructions are not described in detail to avoid obscuring the present disclosure in unnecessary detail.

In aspects, the disclosed methods and systems advantageously reduce the variability of mash distribution on drums of the drum dryers compared to manually operated drum dryers. Indeed, the disclosed systems and methods also advantageously limit or inhibit uncontrolled mash distribution, high sheet variability off the drum, wasted mash that falls off before being converted to a sheet, excess wear on equipment, and employee frustration, among others.

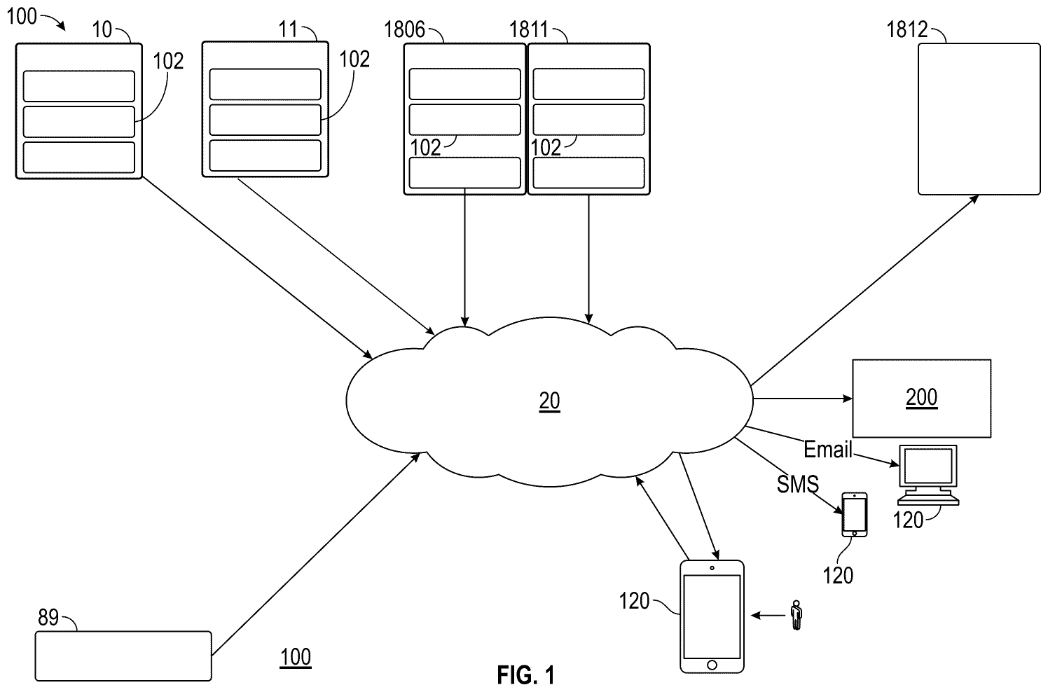

With reference to FIG. 1, the disclosed systems may be non-contact, closed-loop systems such as a closed-loop system 100 of a food processing system or plant. Generally, the closed-loop system 100 includes a dehydrator 10 (e.g., a drum dryer or other food processing equipment, e.g., a conveyor belt) configured for drying mash (e.g., a product), sensors 102 (e.g., an imaging sensor), and a controller 200. Although mash is used as an example, other products are contemplated. In aspects, the closed-loop system 100 can include a cooker (e.g., for cooking the product) and/or a masher (e.g., for mashing the product) that are operably coupled to the dehydrator 10. The closed-loop system 100 is configured to adjust control parameters of a component 11 of the system 100 (e.g., a cooker, a masher, a dehydrator) to reduce variation of mash distribution on a drum of the drum dryer. Although a drum dryer is used as an example, any type of dehydrator may be used. The component includes any component of the system 100 that could change the mash qualities that enter the dehydrator, such as mash rate, temperature, stickiness, chunkiness, and/or additive concentration.

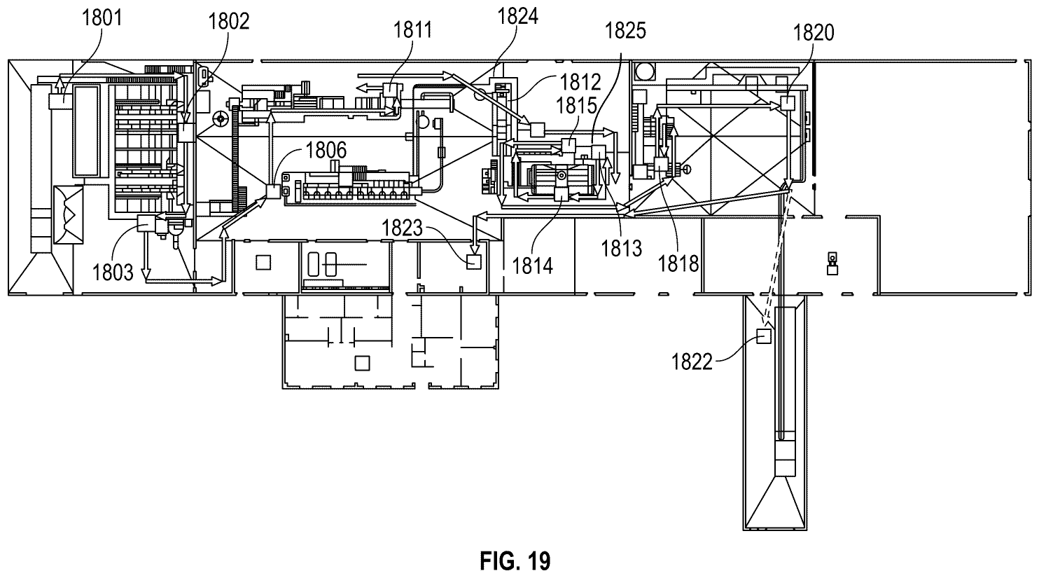

The closed-loop system 100 described herein may integrate more components of a food processing system other than the drum dryer 10, the cooker 1825, and/or the masher 1824 (FIG. 19). Upstream equipment may be responsible for feeding, cleaning, peeling, sorting, cutting, blanching, cooling, cooking, mashing, and weighing the mash before placed onto the drum of the drum dryer 10 for drying. For example, the closed-loop system 100 may include a cooler outlet 1806 of a steam peeler or a wet optical sorter 1811. Observations in these areas can further improve the stability of the mash on the drum dryer 10. The system 100 leverages modern ML (Machine Learning) and AI (Artificial Intelligence) to enable a self-learning/optimizing system to converge on optimal mash control on the drum dryer 10.

Key process indicators (KPI) for various steps of the operation may be evaluated by the closed-loop system 100. For example, during a raw receiving step, KPIs may include load planning, bin steering, bin change notices, material inspection, and/or maintenance. For example, during a peel and sort step, KPIs may include even flow level, line rate, dry brush slop, trench foam, and/or remaining peel percentage.

In aspects, the one or more sensors 102 can include any suitable sensors such as, for example, an imaging sensor, an encoder (e.g., an angular encoder), pressure sensor, flow meter, LIDAR, radar, ultrasonic sensing, feeler gauges, limit switches, etc., or combinations thereof. An angular encoder may be in the form of a position sensor that measures the angular position of a rotating shaft. In aspects, the sensor 102 may include an imaging device configured to capture images of the mash as the mash is processed. The images may include visible light, infrared light, hyperspectral imaging, etc. The sensor 102 may be configured to determine mash distribution in the drum of the drum dryer 10 and or during other processing.

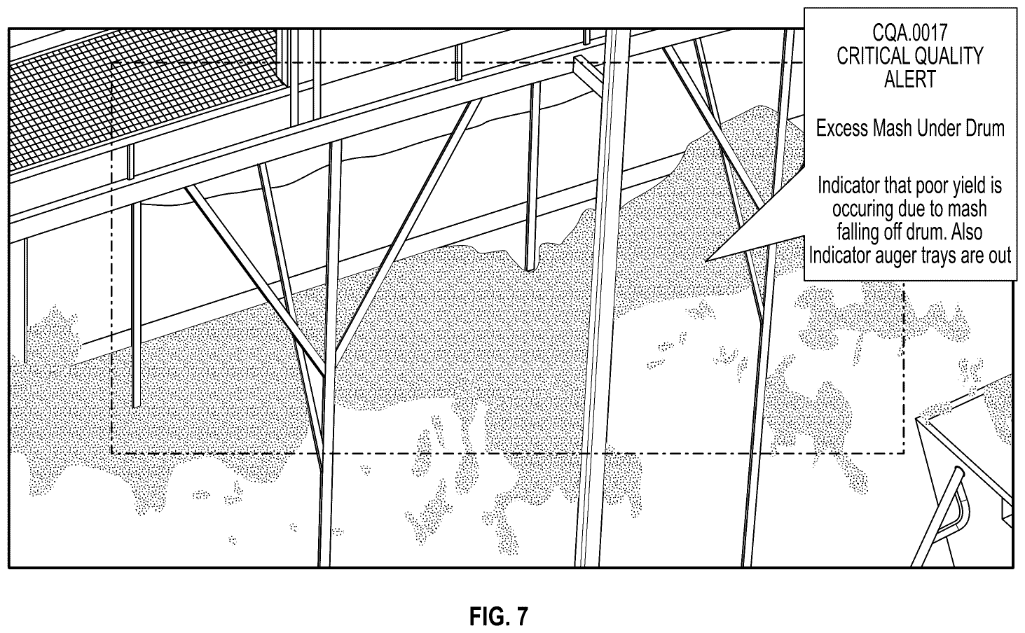

For example, the sensor 102 (e.g., an imaging device) may capture images of mash as the mash is dried by the drum dryer 10. The imaging device may communicate images to the controller 200. The controller 200 may analyze the images using image recognition. For example, the controller 200 may determine that the mash uniformity from the center of a roller to the edge of the roller is poor and is creating a lacy flake (FIG. 7) and is causing excess mash to fall into the hopper, thus wasting mash. The controller 200 may cause the closed-loop system 100 to verify a flow rate of additives (using a flow rate sensor) and automatically adjust settings such as the flow rate of additives by actuating a valve configured to control the flow rate of additives. In another example, the controller 200, may cause the system 100 to automatically adjust the mash ribbon settings of the drum dryer 10 in response to the determination of poor mash uniformity.

In aspects, the sensor(s) 102 may be connected (e.g., directly) and/or may be standalone components that may be connected via wide area network (WAN). In aspects, sensor(s) 102 may be aggregated in the cloud based on provisioning settings. In aspects, the sensor(s) 102 may include, for example, low-power wide area network technology (LPWAN) which may be long-range (LoRa).

In aspects, the controller 200 may determine changes in the condition of the mash based on comparing the generated signal to predetermined data.

The controller 200 is configured to receive data from the sensors 102 as well as from external data sources, such as temperature sensors 89, to make and/or refine predictions indicative of a condition of the mash (uniformity, flakiness, etc.). This prediction enables the controller 200 to determine the condition of the mash based on predetermined data (e.g., historical data). For example, the prediction may be based on comparing the determined changes in the condition of at least one component of the system 100 to predetermined data.

The system 100 may display alerts regarding the sensor 102 reading and/or controller 200 determinations. The predictions may be transmitted to a user device 120, by the controller 200, for display and/or further analysis.

In aspects, the data and/or predictions may be processed by a data visualization system. Data visualization is the graphical representation of information and data. By using visual elements like charts, graphs, and maps, data visualization tools provide an accessible way to see and understand trends, outliers, and patterns in data.

In aspects, the closed-loop system 100 may be implemented in the cloud 20. For instance, Linux, which may run a Python script, for example, can be utilized to effectuate prediction.

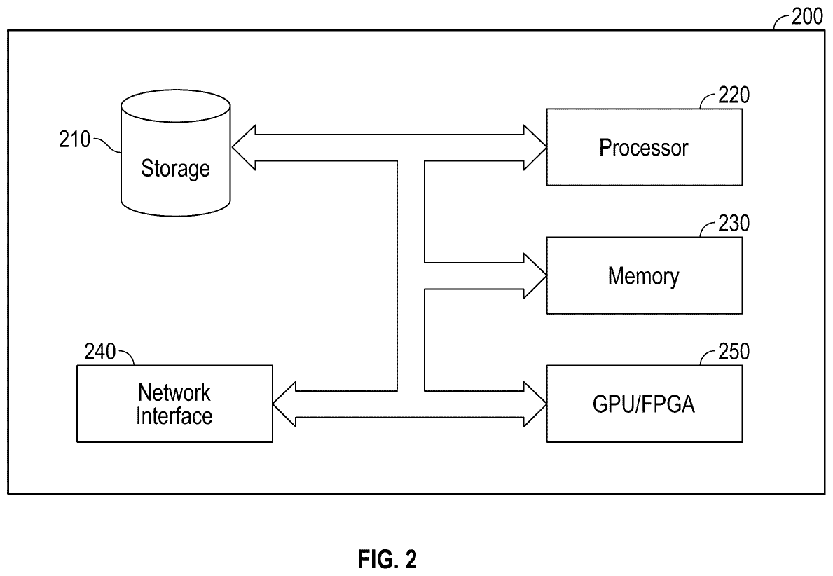

FIG. 2 illustrates that controller 200 includes a processor 220 connected to a computer-readable storage medium or a memory 230. The computer-readable storage medium or memory 230 may be a volatile type of memory, e.g., RAM, or a non-volatile type of memory, e.g., flash media, disk media, etc. In various aspects of the disclosure, the processor 220 may be another type of processor, such as a digital signal processor, a microprocessor, an ASIC, a graphics processing unit (GPU) 250, a field-programmable gate array (FPGA), or a central processing unit (CPU). In certain aspects of the disclosure, network inference may also be accomplished in systems that have weights implemented as memristors, chemically, or other inference calculations, as opposed to processors.

In aspects of the disclosure, the memory 230 can be random access memory, read-only memory, magnetic disk memory, solid-state memory, optical disc memory, and/or another type of memory. In some aspects of the disclosure, the memory 230 can be separate from the controller 200 and can communicate with the processor 220 through communication buses of a circuit board and/or through communication cables such as serial ATA cables or other types of cables. The memory 230 includes computer-readable instructions that are executable by the processor 220 to operate the controller 200. In other aspects of the disclosure, the controller 200 may include a network interface 240 to communicate with other computers or to a server. A storage device 210 may be used for storing data.

The disclosed method may run on the controller 200 or on a user device, including, for example, on a mobile device, an IoT device, or a server system.

In aspects, an analytics engine (e.g., a machine learning model and/or classical analytics) may be configured to perform the determinations. The analytics engine includes a machine learning model. The machine learning model may be based on a deep learning network, a classical machine learning model, or combinations thereof.

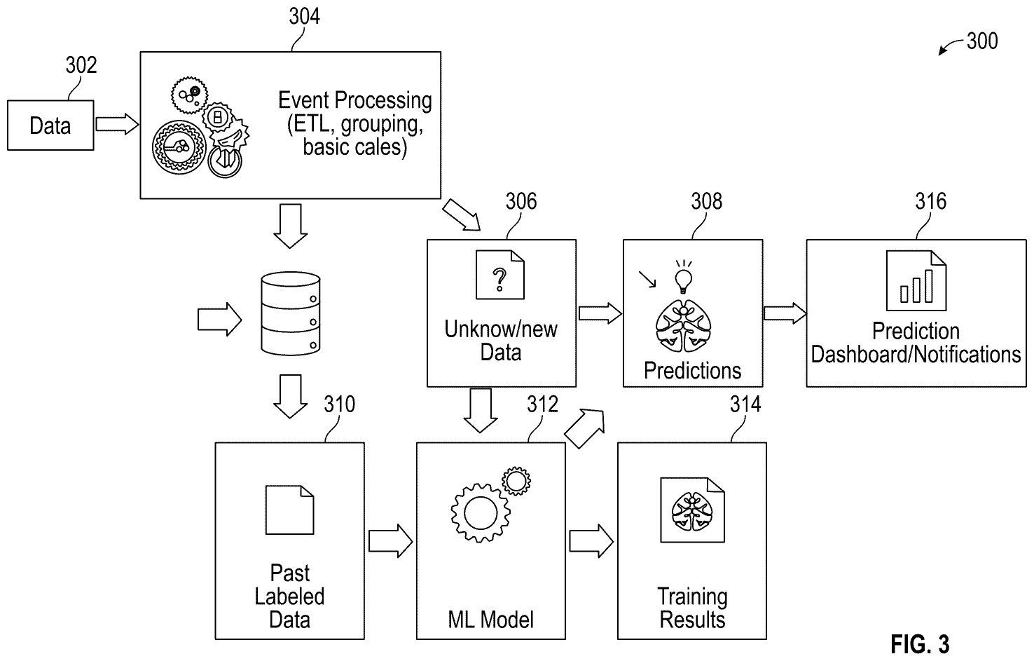

FIG. 3 illustrates a machine learning model 300 and dataflow\storage\feedback of the system. The machine learning model 300 can be hosted at the controller 200 or in the cloud (e.g., a remote server). The machine learning model 300 may include one or more convolutional neural networks (CNN).

In machine learning, a convolutional neural network (CNN) is a class of artificial neural network (ANN), most commonly applied to analyzing visual imagery. The convolutional aspect of a CNN relates to applying matrix processing operations to localized portions of an image, and the results of those operations (which can involve dozens of different parallel and serial calculations) are sets of many features that are used to train neural networks. A CNN typically includes convolution layers, activation function layers, and pooling (typically max pooling) layers to reduce dimensionality without losing too many features. Additional information may be included in the operations that generate these features. Providing unique information that yields features that give the neural networks information can be used to provide an aggregate way to differentiate between different data inputs to the neural networks. In aspects, the machine learning model 312 may include a combination of one or more deep learning networks (e.g., a CNN) and classical machine learning models (e.g., an SVM, a decision tree, etc.). For example, the machine learning model 312 may include two deep learning networks.

Data 302 may be pre-processed 304 by grouping or ETL (extract transform and load) which is configured to combine data from multiple sources into a single consistent data store. Prior data may be labeled 310 and fed into the machine learning model 312 for training 314. The unknown or new data 306 is provided as an input to the machine learning model 312 for the machine learning model 312 to make a prediction 308 (for example, an identification in an image). The predicted results may be displayed on dashboard 316.

In aspects, two labeling methods for the training data may be used, one based on a connection with a computer maintenance system (CMMS), and one based on user input. In aspects, the user can be prompted to label data, or can provide the data manually (e.g., at time-of-service events).

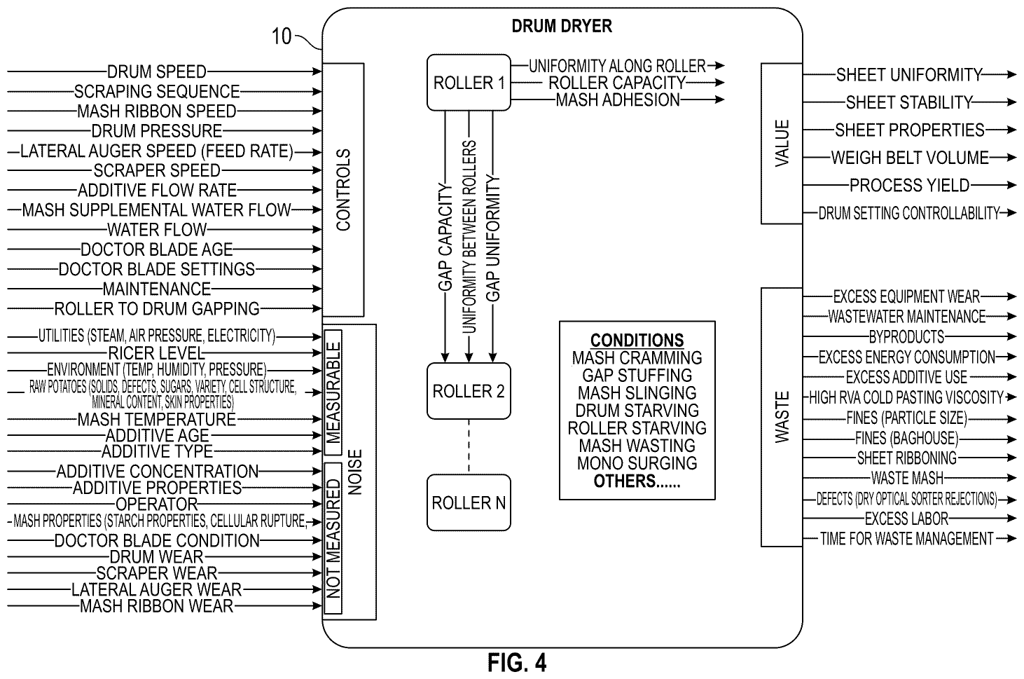

Regarding FIG. 4, a block diagram of the drum dryer 10 of system 100 is shown. The controller 200 may adjust various control parameters of the drum dryer 10 to effectuate uniform mash distribution. The control parameter includes at least one of a drum speed, a scraping sequence, a mash ribbon speed, a drum pressure, a feed rate, a scraper speed, an additive flow rate, a mash supplemental water flow, a water flow, a doctor blade age, or a roller to drum gapping.

The controller 200 may determine one or more parameters of the mash, such as sheet uniformity, sheet stability, sheet properties, weight belt volume, process yield, and/or the drum setting controllability based on the one or more sensor signals.

The disclosed system 100 provides the benefit of reducing waste from the drum drying process. The waste may include, for example, excess equipment wear, wastewater maintenance, byproducts, excess energy consumption, excess additive use, high rapid visco-analysis (RVA) cold pasting viscosity, particle size, sheet ribboning, waste mesh, defects (e.g., dry optical sorter type rejections), excess labor, and/or time for waste management.

The controller 200 may further determine one or more of the following conditions, including, for example, mash cramming, gap stuffing, mash slinging, drum starving, roller starving, mash wasting, and/or mono surging, based on the sensor signal.

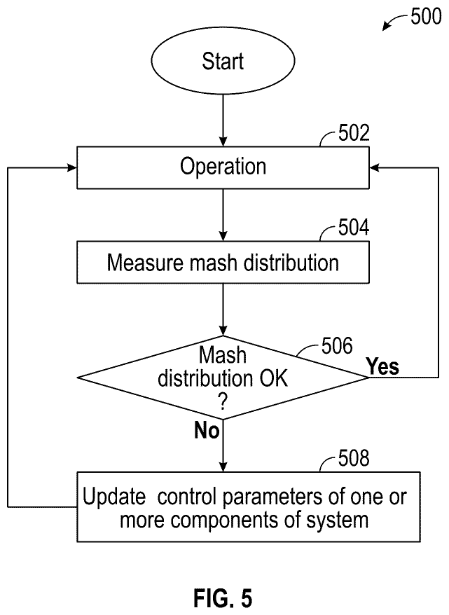

With reference to FIG. 5, a flow diagram for a method 500 for controlling mash distribution is shown. Although the steps of FIG. 5 are shown in a particular order, the steps need not all be performed in the specified order, and certain steps can be performed in another order. For example, FIG. 5 will be described below, with a server (e.g., controller 200 of FIG. 2) performing the operations. In various aspects, the operations of FIG. 5 may be performed all or in part by the controller 200 of FIG. 1. In aspects, the operations of FIG. 5 may be performed all or in part by another device, for example, a mobile device and/or a client computer system. These and other variations are contemplated to be within the scope of the present disclosure.

Initially, at step 502, an operation is performed. For example, the operation may include drying a product (e.g., mash) with the drum dryer 10. Next, at step 504, the controller 200 measures the product distribution. For example, the controller 200 may measure the distribution of the product along a surface of the drum dryer (e.g., an inner surface). The product distribution may be measured using sensor 102. For example, an image of the mesh may be captured and analyzed using machine vision (e.g., a camera). The sensor 102 (FIG. 1) may further include a pressure sensor, a flow meter, LIDAR, radar, ultrasonic sensing, a feeler gauge, and/or a limit switch.

At step 506, the controller 200 determines if the mash distribution is adequate. For example, the controller 200 may determine differences between the distribution of the product along the surface of the drum dryer and a predetermined distribution of the product along the surface of the drum dryer.

In aspects, the controller 200 may determine a metric indicating an adequacy of the distribution of the product in the drum.

In aspects, the controller 200 may utilize a machine learning network to determine if the mash distribution is adequate. The machine learning network may determine that the product distribution is not adequate.

In aspects, the controller 200 may identify, by a machine vision model, one or more locations of the product in the drum dryer based on the image and determine by a machine learning model the metric indicating adequacy of distribution of the product (e.g., mash) in the drum dryer 10 (FIG. 1) based on the one or more identified locations of the product across the drum dryer.

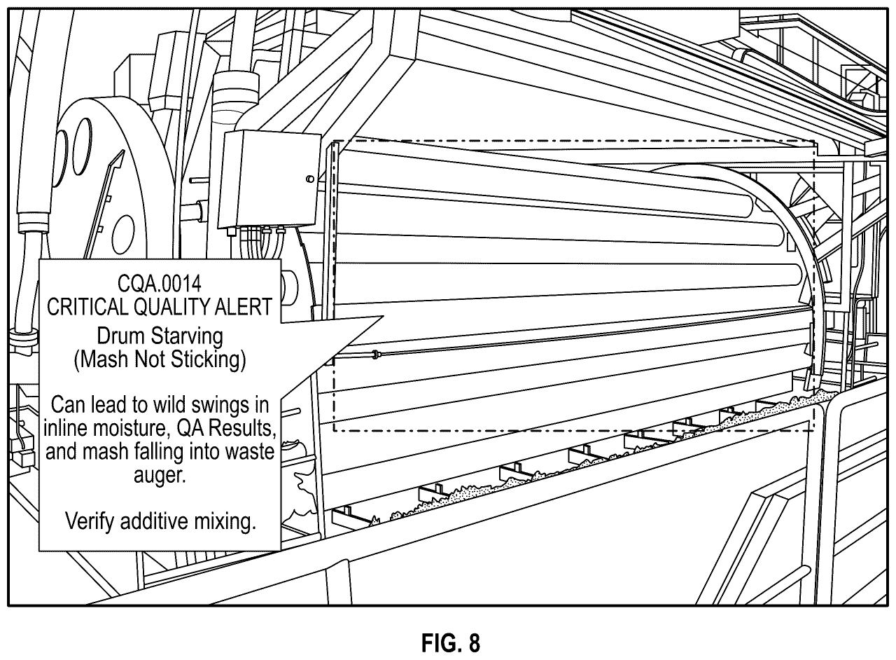

For example, the controller 200 may determine that the mash is not sticking to the roller (e.g., the roller is starving), as shown in FIG. 8. The mash not sticking to the roller could lead to wild swings in inline moisture and mash falling into a waste augur. If the controller 200 determines that the product distribution is adequate, then the operation continues.

At step 508, the controller 200 adjusts control parameters of one or more components of the system. After the control parameters are adjusted an operation may be performed by the one or more components of the system.

For example, the controller 200 may adjust a control parameter of the drum dryer in response to the determined differences to reduce the differences and control the distribution of the product along the surface of the drum dryer 10. In aspects, the control parameter includes a drum speed, a scraping sequence, a mash ribbon speed, a drum pressure, a feed rate, a scraper speed, an additive flow rate, a mash supplemental water flow, a water flow, a doctor blade age, and/or a roller-to-drum gapping.

In another example, the control parameter of the drum dryer may be adjusted by actuating an actuator configured to operate one or more components of the drum dryer and/or changing the speed of a variable speed motor that controls an angular velocity of the drum dryer.

In one example, drum speed or drum pressure may be updated in response to inadequate product distribution. In aspects, the machine learning model may determine which control parameter to update and by how much. Thus, the system 100 is configured to operate automatically in a closed-loop manner to reduce waste. For example, the sensor 102 captures information regarding the product distribution within the roller, between the rollers, and in the gaps between rollers, which is fed back to control the drum dryer 10 by the controller 200 in various ways, such as drum speed, drum pressure, drum temperature, scraper sequencing, mash ribbon speed, mash feed rate, roller to drum spacing.

Information regarding the mash distribution within the roller, between the rollers, and in the gaps between rollers can be fed back to control the drum in various ways, such as by automatically controlling drum speed, drum pressure/temperature, scraper sequencing, mash ribbon speed, mash feed rate, roller to drum spacing, additive concentration, mash water flow, scraper speed, scraper direction. In aspects, the controller 200 may cause the system 100 to capture sounds using a sensor (e.g., a microphone). The controller 200 may cause the system 100 to consider measurable noise factors to operate in alternate modes based on environmental conditions such as utility status, mash hopper level, ambient temperature/pressure/humidity, raw material characteristics, mash temperature, additive types, and/or additive age.

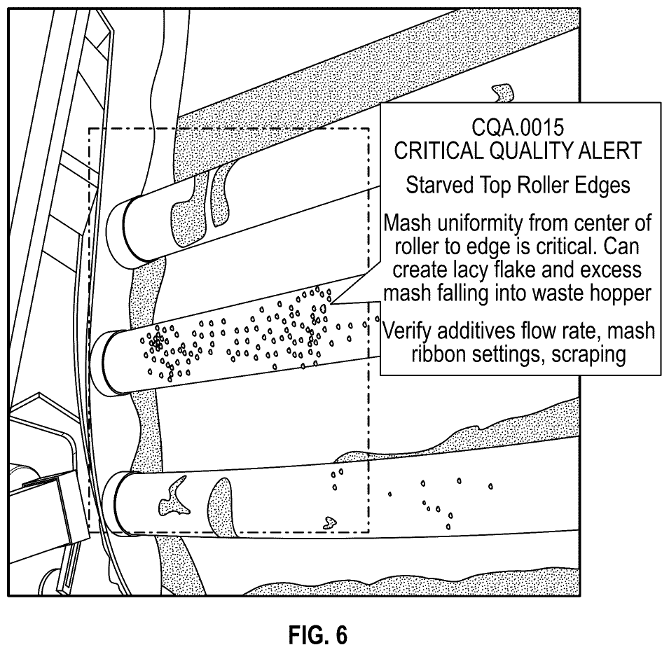

Referring to FIG. 6, a mash-starved top roller edge of a drum dryer is shown. Mash uniformity from the center of the roller to the edge is important for reducing mash waste. Mash that is unevenly distributed across the roller can create a lacy flake and cause excess mash to fall into a waste hopper. When detected by the disclosed system, the disclosed system 100 enables the verification of a flow rate of additives to the mash, mash ribbon settings, and/or scraping.

Referring to FIG. 7, excess mash under the drum dryer is shown. The excess mash under the drum dryer may be an indicator that poor yield is occurring due to mash falling off the drum.

Referring to FIG. 8, a starved drum is shown. In this case, the mash is not sticking to the drum. The drum starving can lead to wild swings in inlet moisture, which may cause mash to fall into the waste augur of the drum dryer. When detected, the system 100 may provide an indication to the user that additive mixing needs to be checked.

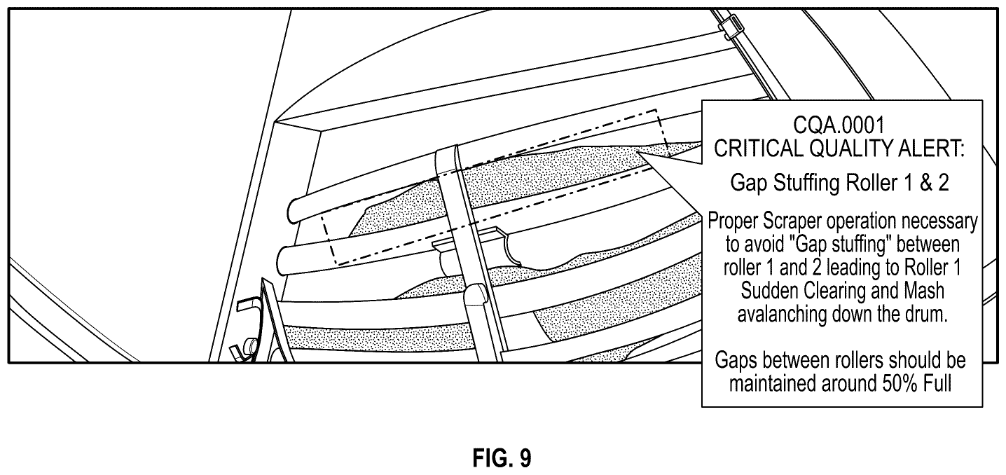

Referring to FIG. 9, a “gap stuffing” of rollers is shown. Proper scraper operation is necessary to avoid “gap stuffing” between the rollers. The system 100 may provide an indication to the user that gaps between the rollers should be maintained to below a predetermined threshold amount, such as about 50%. In another aspect, the system 100 may adjust the operation of another component of the drum dryer 10 (e.g., the scraper) in response to the gap exceeding the predetermined threshold.

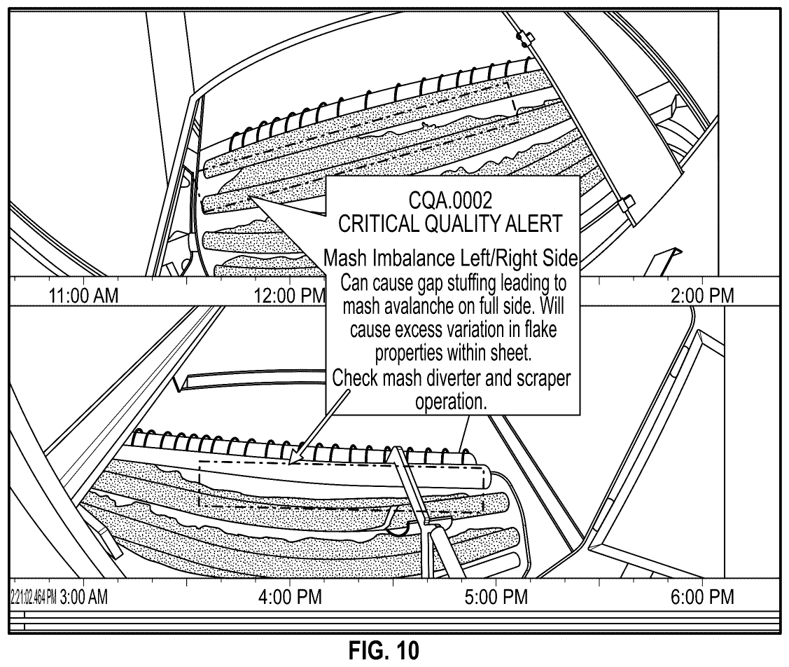

Referring to FIG. 10, a mash imbalance on the left and right side of the roller is shown. Mash imbalance may cause gap stuffing, which may lead to an avalanche on the full side. Mash imbalance may cause excess variation in the flake properties of the sheet of mash. The system 100 may provide an indication to the user to check the mash diverter and scraper operation.

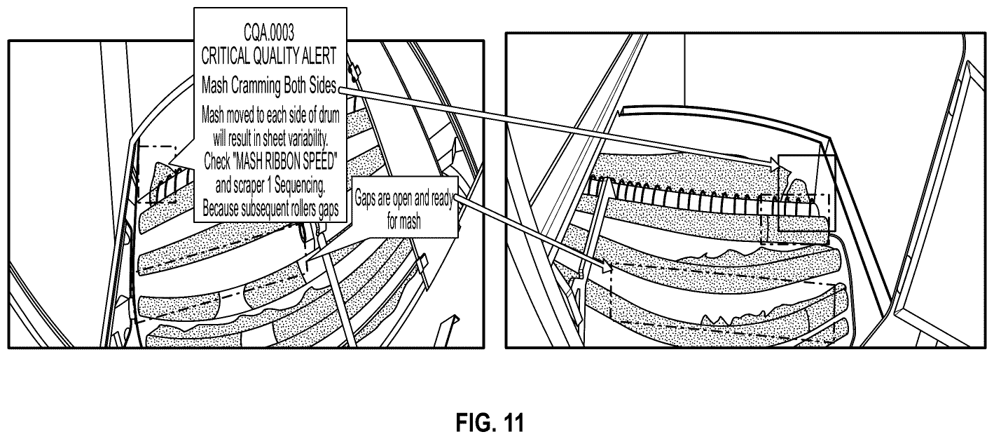

Referring to FIG. 11, a roller with mash cramming both sides is shown. The system 100 may provide an indication to the user to check the mash ribbon speed and/or scraper sequencing.

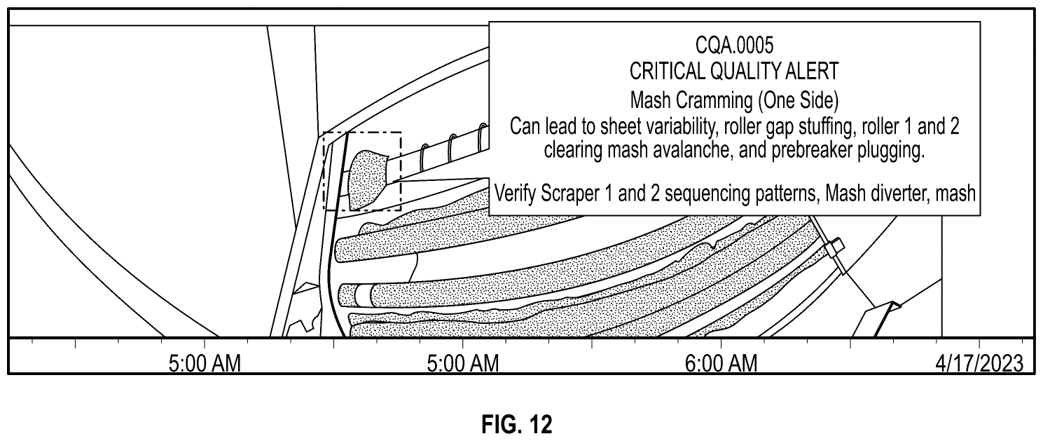

Referring to FIG. 12, a roller with mash cramming on one side is shown. This may cause sheet variability, roller gap stuffing, mash avalanching, pre-breaker plugging. The system 100 may provide an indication to the user to verify scraper sequencing patterns and/or check the mash diverter.

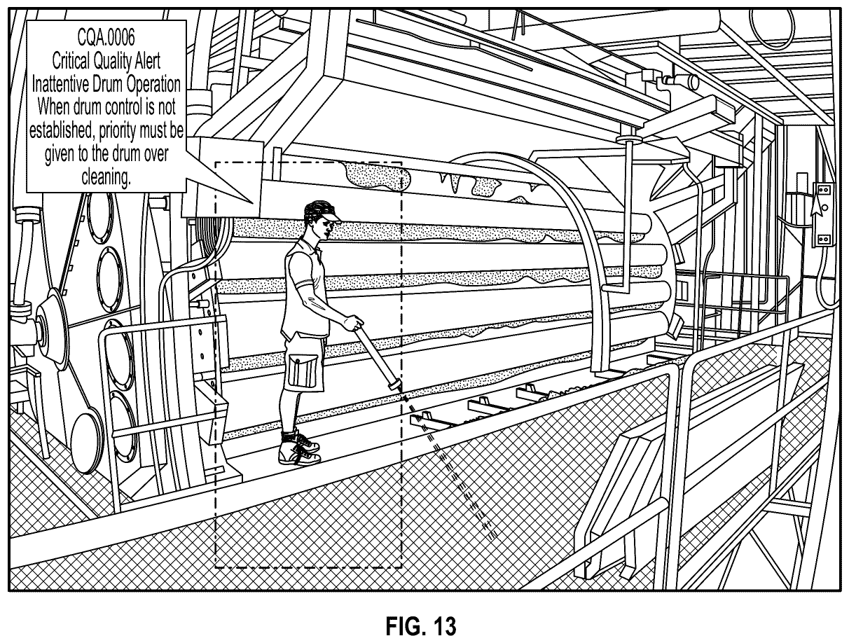

Referring to FIG. 13, a result of an inattentive drum operation is shown. The system 100 may provide an indication to the user to shift priority from cleaning to the drum operation. For example, the system 100 may determine that drum control is not established, and that the user should shift priority from cleaning to the drum operation.

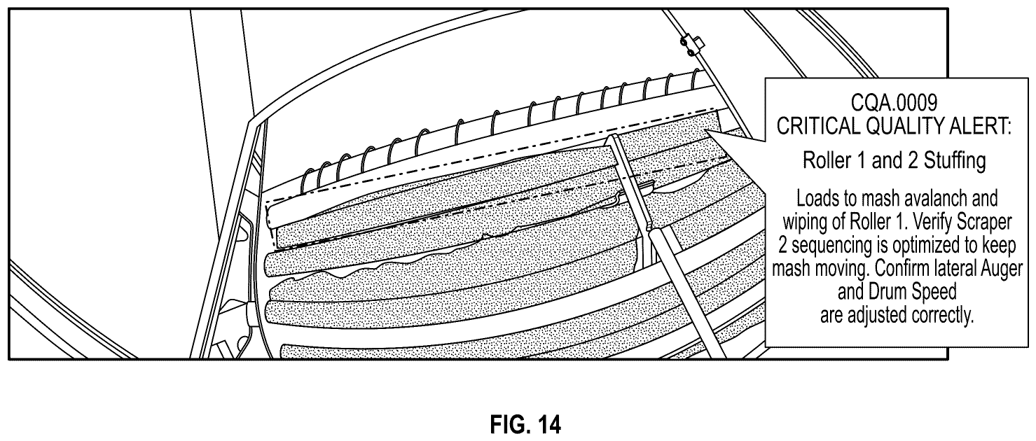

Referring to FIG. 14, roller stuffing is shown. The system 100 may provide an indication to the user that the lateral augur and/or drum speed is adjusted correctly. In aspects, the system 100 may adjust the lateral augur and/or drum speed of the drum dryer 10.

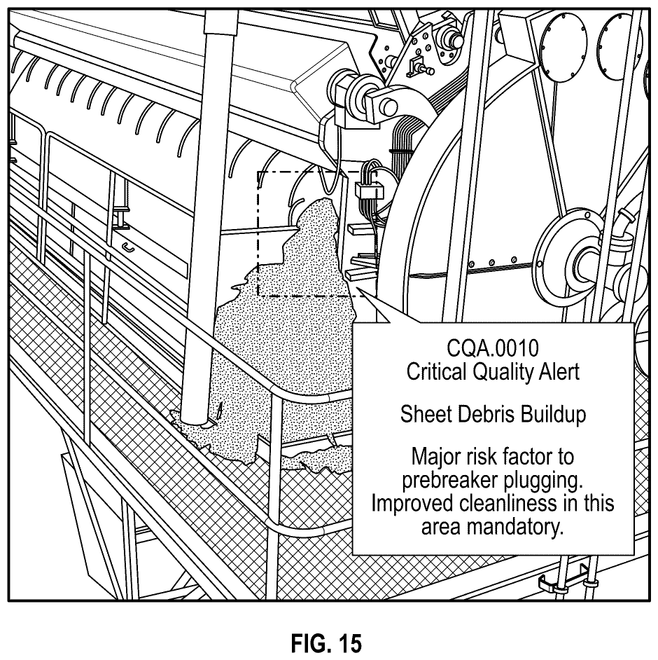

Referring to FIG. 15, sheet debris buildup is shown. The system 100 may provide an indication to the user that there is sheet debris buildup.

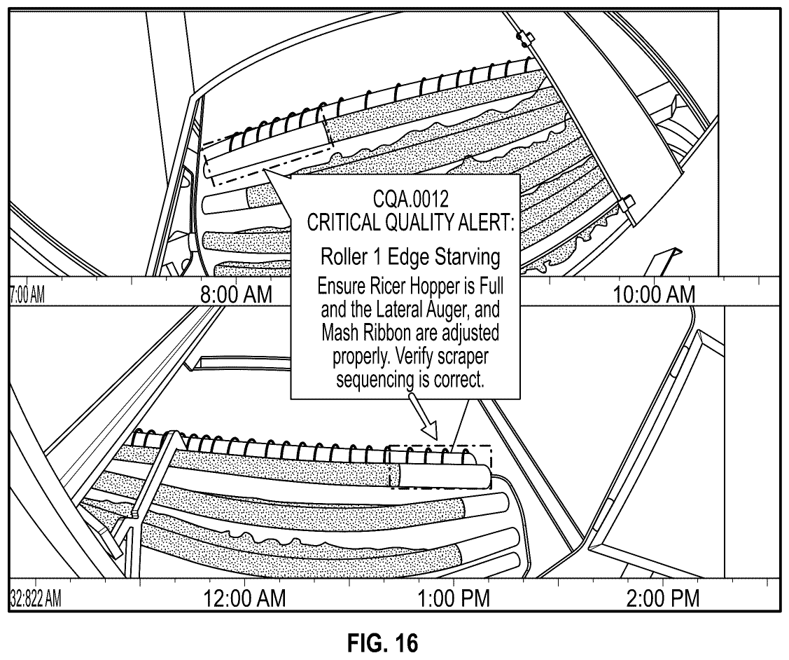

Referring to FIG. 16, roller edge starving is shown. The system 100 may provide an indication to the user to verify that the scraper sequencing is correct or to ensure that the hopper is full and that the lateral augur and/or mash ribbon are adjusted correctly.

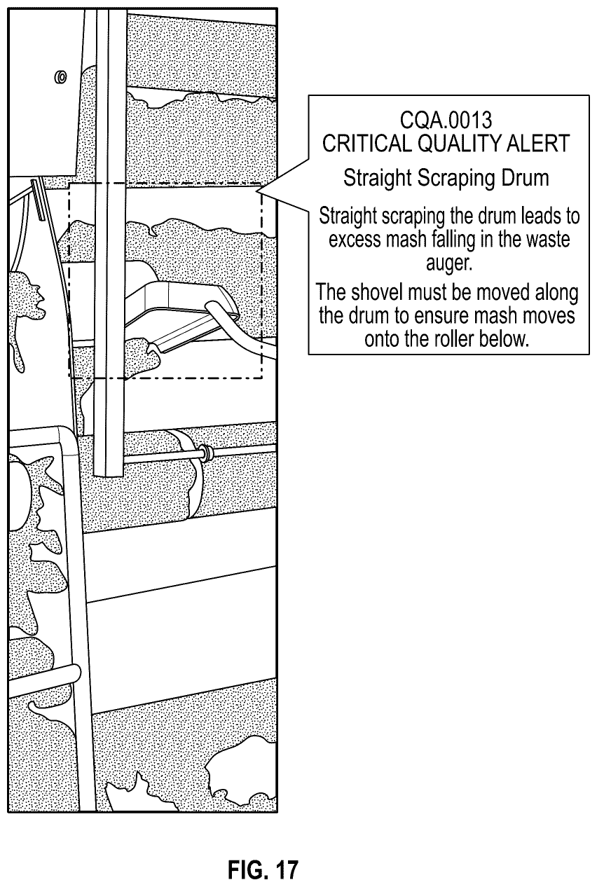

Referring to FIG. 17, straight scraping the drum of the drum dryer is shown. Straight scraping the drum leads to excess mash falling into the waste hopper. The system 100 may provide an indication to the user that the shovel must be moved along the drum to ensure that the mash moves onto the roller below. The system 100 provides the benefit of reducing excess mash waste.

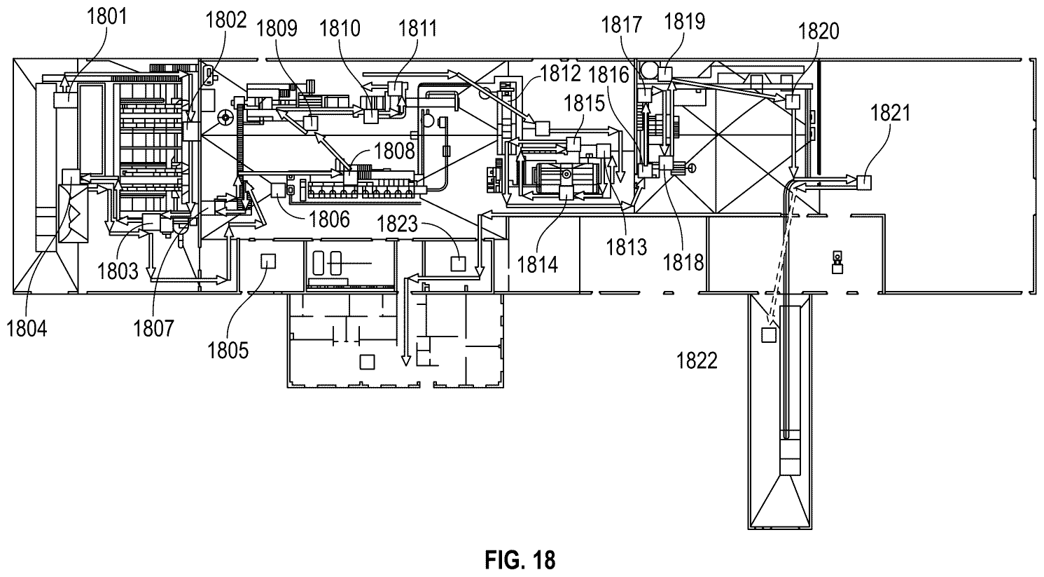

FIGS. 18 and 19 illustrate exemplary floor plans and flow paths of a food processing plant used with the system 100 of FIG. 1. The sensors 102 of the system 100 (FIG. 1) may be located at one or more locations in the food processing plant. The drum dryer 10 of FIG. 1 is an illustrative example of such a location.

Initially, potatoes are received at receiving point 1801 and placed in holding bin 1802. For example, the sensor 102 may monitor the quantity of potatoes in the holding bin 1802 and detect an overflow. The potatoes may go through destoning at a human-machine interface (HMI) destoning station 1803. Some amount of waste is removed at this point and placed in the waste holding bin 1804. The maintenance team 1805 may be positioned to effectuate maintenance based on the determinations form the system 100. At the cooler outlet 1806 of the steam peeler, the potatoes may further be monitored by the system 100. For example, the temperature of the cooler outlet 1806 may be monitored. Next, the potatoes enter a wet optical sorter 1811, where the potatoes may be monitored by the system 100. At the floating debris remover 1807, floating debris may be removed from the wet optical sorter 1811.

At a camera display 1812, the user may monitor for alerts based on the determinations made by the system 100. Next, at operation 1813 the potatoes enter the drum dryer 10. At location 1814, the mash is converted into a sheet. At operation 1815, an additive may be added to the mash. Next, the mash enters the optical sorter HMI 1818. The optical sorter discharge 1816 supplies the output of the optical sorter 1818 to the baghouse 1819. The mash enters the baghouse 1819, where the mash is packaged for distribution. At operation 1820, the bagged mash is labeled, and metal detection is performed. The bagged mash may be stored in the warehouse 1821. At location 1822, a tanker trailer may be located to ship the bagged mash. The system 100 may generate quality assurance (QA) records 1823 for future use and analysis.

Moreover, the disclosed structure can include any suitable mechanical, electrical, and/or chemical components for operating the disclosed system or components thereof. For instance, such electrical components can include, for example, any suitable electrical and/or electromechanical, and/or electrochemical circuitry, which may include or be coupled to one or more printed circuit boards. As used herein, the term “controller” includes “processor,” “digital processing device” and like terms, and are used to indicate a microprocessor or central processing unit (CPU). The CPU is the electronic circuitry within a computer that carries out the instructions of a computer program by performing the basic arithmetic, logical, control and input/output (I/O) operations specified by the instructions, and by way of non-limiting examples, include server computers. In some aspects, the controller includes an operating system configured to perform executable instructions. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. In some aspects, the operating system is provided by cloud computing.

In some aspects, the term “controller” may be used to indicate a device that controls the transfer of data from a computer or computing device to a peripheral or separate device and vice versa, and/or a mechanical and/or electromechanical device (e.g., a lever, knob, etc.) that mechanically operates and/or actuates a peripheral or separate device.

In aspects, the controller includes a storage and/or memory device. The storage and/or memory device is one or more physical apparatus used to store data or programs on a temporary or permanent basis. In some aspects, the controller includes volatile memory and requires power to maintain stored information. In various aspects, the controller includes non-volatile memory and retains stored information when it is not powered. In some aspects, the non-volatile memory includes flash memory. In certain aspects, the non-volatile memory includes dynamic random-access memory (DRAM). In some aspects, the non-volatile memory includes ferroelectric random-access memory (FRAM). In various aspects, the non-volatile memory includes phase-change random access memory (PRAM). In certain aspects, the controller is a storage device including, by way of non-limiting examples, CD-ROMs, DVDs, flash memory devices, magnetic disk drives, magnetic tapes drives, optical disk drives, and cloud computing-based storage. In various aspects, the storage and/or memory device is a combination of devices such as those disclosed herein.

In some aspects, the controller includes a display to send visual information to a user. In various aspects, the display is a cathode ray tube (CRT). In various aspects, the display is a liquid crystal display (LCD). In certain aspects, the display is a thin film transistor liquid crystal display (TFT-LCD). In aspects, the display is an organic light emitting diode (OLED) display. In certain aspects, on OLED display is a passive-matrix OLED (PMOLED) or active-matrix OLED (AMOLED) display. In aspects, the display is a plasma display. In certain aspects, the display is a video projector. In various aspects, the display is interactive (e.g., having a touch screen or a sensor such as a camera, a 3D sensor, a LiDAR, a radar, etc.) that can detect user interactions/gestures/responses and the like. In some aspects, the display is a combination of devices such as those disclosed herein.

The controller may include or be coupled to a server and/or a network. As used herein, the term “server” includes “computer server,” “central server,” “main server,” and like terms to indicate a computer or device on a network that manages the system, components thereof, and/or resources thereof. As used herein, the term “network” can include any network technology including, for instance, a cellular data network, a wired network, a fiber optic network, a satellite network, and/or an IEEE 802.11a/b/g/n/ac wireless network, among others.

In various aspects, the controller can be coupled to a mesh network. As used herein, a “mesh network” is a network topology in which each node relays data for the network. All mesh nodes cooperate in the distribution of data in the network. It can be applied to both wired and wireless networks. Wireless mesh networks can be considered a type of “Wireless ad hoc” network. Thus, wireless mesh networks are closely related to Mobile ad hoc networks (MANETs). Although MANETs are not restricted to a specific mesh network topology, Wireless ad hoc networks or MANETs can take any form of network topology. Mesh networks can relay messages using either a flooding technique or a routing technique. With routing, the message is propagated along a path by hopping from node to node until it reaches its destination. To ensure that all its paths are available, the network must allow for continuous connections and must reconfigure itself around broken paths, using self-healing algorithms such as Shortest Path Bridging. Self-healing allows a routing-based network to operate when a node breaks down or when a connection becomes unreliable. As a result, the network is typically quite reliable, as there is often more than one path between a source and a destination in the network. This concept can also apply to wired networks and to software interaction. A mesh network whose nodes are all connected to each other is a fully connected network.

In some aspects, the controller may include one or more modules. As used herein, the term “module” and like terms are used to indicate a self-contained hardware component of the central server, which in turn includes software modules. In software, a module is a part of a program. Programs are composed of one or more independently developed modules that are not combined until the program is linked. A single module can contain one or several routines, or sections of programs that perform a particular task.

As used herein, the controller includes software modules for managing various aspects and functions of the disclosed system or components thereof.

The disclosed structure may also utilize one or more controllers to receive various information and transform the received information to generate an output. The controller may include any type of computing device, computational circuit, or any type of processor or processing circuit capable of executing a series of instructions that are stored in memory. The controller may include multiple processors and/or multicore central processing units (CPUs) and may include any type of processor, such as a microprocessor, digital signal processor, microcontroller, programmable logic device (PLD), field programmable gate array (FPGA), or the like. The controller may also include a memory to store data and/or instructions that, when executed by the one or more processors, cause the one or more processors to perform one or more methods and/or algorithms.

Any of the herein described methods, programs, algorithms, or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

The machine learning (“ML”) model may be the most efficient for complex failures. However, basic logic can be used for simpler failure modes. Since these vary with a complex inference space, ML can assist in predicting abnormal operation and simplify user and subject matter expert input by giving a simple labeling method.

In aspects, the abnormal operation may be predicted by generating, based on the received first set of sensor signals, a data structure that is formatted to be processed through one or more layers of a machine learning model. The data structure may have one or more fields structuring data. The abnormal operation may further be predicted by processing data that includes the data structure, through each of the one or more layers of the machine learning model that has been trained to predict a likelihood that a particular piece of equipment may require maintenance; and generating, by an output layer of the machine learning model, an output data structure. The output data structure may include one or more fields structuring data indicating a likelihood that a particular piece of equipment may require maintenance. The abnormal operation requirement may further be predicted by processing the output data structure to determine whether data organized by the one or more fields of the output data structure satisfies a predetermined threshold, wherein the output data structure includes one or more fields structuring data indicating a likelihood that a particular piece of equipment may require maintenance; and generating the prediction based on the output data of the machine learning model. The prediction includes the abnormal operation. The training may include supervised learning.

Although a system for effectuating control of uniformity of a product is used as an example, the disclosed systems and methods may be used advantageously in other environments.

In one aspect of the present disclosure, the disclosed algorithms may be trained using supervised learning. Supervised learning is the machine learning task of learning a function that maps an input to an output based on example input-output pairs. The ML model infers a function from labeled training data consisting of a set of training examples. In supervised learning, each example is a pair, including an input object (typically a vector) and a desired output value (also called the supervisory signal). A supervised learning algorithm analyzes the training data and produces an inferred function, which can be used for mapping new examples. In various embodiments, the algorithm may correctly determine the class labels for unseen instances. This requires the learning algorithm to generalize from the training data to unseen situations in a “reasonable” way.

In various embodiments, the neural network may be trained using training data, which may include, for example, different mash characteristics. The algorithm may analyze this training data and produce an inferred function that may allow the algorithm to identify component failures or changes in health of such components, based on the generalizations the algorithm has developed from the training data. In various embodiments, training may include at least one of supervised training, unsupervised training, and/or reinforcement learning.

In various embodiments, the neural network may include, for example, a three-layer temporal convolutional network with residual connections, where each layer may include three parallel convolutions, where the number of kernels and dilations increase from bottom to top, and where the number of convolutional filters increases from bottom to top. It is contemplated that a higher or lower number of layers may be used. It is contemplated that a higher or lower number of kernels and dilations may also be used.

The system includes a first cloud server which includes an interface for the system, a device cloud (e.g., a Particle cloud) configured for communication between connected devices and the system, and a firmware server, which is configured to push firmware updates to components of the system. System devices may include a cellular-enabled microcontroller (e.g., a Particle Boron) and a CBM module. The cellular-enabled microcontroller includes a cellular receiver/transmitter, a wireless receiver/transmitter (e.g., Bluetooth and/or WIFI), power management functions, firmware update functions, watchdog functions, power management integrated circuits (PMIC), power on-self test (POST) functions, a universal asynchronous receiver/transmitter (UART), and a general-purpose IO (GPIO). The cellular-enabled microcontroller communicates with the condition-based monitor module (CBM module), which is configured for processing signals from sensors. The sensor signals can be sampled by the CBM module at a rate of 1125 KHz, for example. When the CBM module determines one or more operations are completed, the CBM module notifies the system via the cellular-enabled microcontroller.

As can be appreciated, securement of any of the components of the disclosed apparatus can be effectuated using known securement techniques such welding, crimping, gluing, fastening, etc.

Persons skilled in the art will understand that the structures and methods specifically described herein and illustrated in the accompanying figures are non-limiting exemplary aspects, and that the description, disclosure, and figures should be construed merely as exemplary of particular aspects. It is to be understood, therefore, that this disclosure is not limited to the precise aspects described, and that various other changes and modifications may be effectuated by one skilled in the art without departing from the scope or spirit of the disclosure. Additionally, it is envisioned that the elements and features illustrated or described in connection with one exemplary aspect may be combined with the elements and features of another without departing from the scope of this disclosure, and that such modifications and variations are also intended to be included within the scope of this disclosure. Indeed, any combination of any of the disclosed elements and features is within the scope of this disclosure. Accordingly, the subject matter of this disclosure is not to be limited by what has been particularly shown and described.

1. A non-contact, closed-loop system for dehydrator control, the closed-loop system comprising:
a dehydrator;
a sensor configured measure a distribution of a product along a surface of the dehydrator;
a processor; and
a memory, including instructions stored thereon, which, when executed by the processor, cause the non-contact, closed-loop system to:
measure the distribution of the product along the surface of the dehydrator;
determine differences between the distribution of the product along the surface of the dehydrator and a predetermined distribution of the product along the surface of the dehydrator; and
adjust a control parameter of the non-contact, closed-loop system in response to the determined differences to reduce the differences and control the distribution of the product along the surface of the dehydrator when the dehydrator operates.

2. The non-contact, closed-loop system of claim 1, wherein the control parameter includes at least one of a drum speed, a scraping sequence, a mash ribbon speed, a drum pressure, a feed rate, a scraper speed, an additive flow rate, a mash supplemental water flow, a water flow, a doctor blade age, a roller-to-drum gapping, a mash rate, mash temperature, mash stickiness, mash chunkiness, or additive concentration.

3. The non-contact, closed-loop system of claim 2, wherein the control parameter of the non-contact, closed-loop system is adjusted by:
actuating an actuator configured to operate one or more components of the non-contact, closed-loop system including one or more components of at least one of a cooker, a masher, or the dehydrator.

4. The non-contact, closed-loop system of claim 2, wherein the control parameter of the non-contact, closed-loop system is adjusted by:
changing the speed of a variable speed motor that controls an angular velocity of the dehydrator.

5. The non-contact, closed-loop system of claim 1, wherein the instructions, when executed by the processor, further cause the non-contact, closed-loop system to determine one or more parameters of the product based on the measured distribution of the product along the surface of the dehydrator,
wherein the one or more parameters include at least one of a sheet uniformity, a sheet stability, a sheet property, a weight belt volume, a process yield, or a drum setting controllability, and
wherein the non-contact, closed-loop system determines, based on the one or more parameters, differences between the distribution of the product along the surface of the dehydrator and the predetermined distribution of the product along the surface of the dehydrator.

6. The non-contact, closed-loop system of claim 1, wherein the sensor includes an image sensor configured to capture an image of the product in the dehydrator, and
wherein when measuring the distribution of the product, the instructions, when executed by the processor, further cause the non-contact, closed-loop system to access a captured image.

7. The non-contact, closed-loop system of claim 6, wherein when determining differences between the distribution of the product along the surface of the dehydrator and the predetermined distribution of the product along the surface of the dehydrator, the instructions, when executed by the processor, further cause the non-contact, closed-loop system to determine a metric indicating an adequacy of the distribution of the product in the dehydrator.

8. The non-contact, closed-loop system of claim 7, wherein when determining the metric, the instructions, when executed by the processor, further cause the non-contact, closed-loop system to:
identify, by a machine vision model, one or more locations of the product in the dehydrator based on the image; and
determine, by a machine learning model, the metric indicating an adequacy of a distribution of the product in the dehydrator based on the one or more identified locations of the product across the dehydrator.

9. The non-contact, closed-loop system of claim 1, wherein the sensor includes at least one of a pressure sensor, a flow meter, LIDAR, radar, ultrasonic sensing, a feeler gauge, or a limit switch.

10. The non-contact, closed-loop system of claim 1, further comprising an analytics engine configured to perform the determinations, wherein the analytics engine optionally includes at least one of basic logic or a machine learning model, and wherein the machine learning model is based on a deep learning network, a classical machine learning model, or combinations thereof.

11. A computer-implemented method for non-contact, closed-loop dehydrator control, the computer-implemented method comprising:
measuring, by a sensor, a distribution of a product along a surface of a dehydrator of a non-contact, closed-loop system including at least one of a cooker, a masher, or the dehydrator;
determining differences between the distribution of the product along the surface of the dehydrator and a predetermined distribution of the product along the surface of the dehydrator; and
adjusting a control parameter of the non-contact, closed-loop system t in response to the determined differences to reduce the differences and control the distribution of the product along the surface of the dehydrator when the dehydrator operates.

12. The computer-implemented method of claim 11, wherein the product includes mash.

13. The computer-implemented method of claim 11, wherein the control parameter includes at least one of a drum speed, a scraping sequence, a mash ribbon speed, a drum pressure, a feed rate, a scraper speed, an additive flow rate, a mash supplemental water flow, a water flow, a doctor blade age, a roller-to-drum gapping, a mash rate, mash temperature, mash stickiness, mash chunkiness, or additive concentration.

14. The computer-implemented method of claim 13, wherein the control parameter of the dehydrator is adjusted by at least one of:
actuating an actuator configured to operate one or more components of the dehydrator; or
changing the speed of a variable speed motor that controls an angular velocity of the dehydrator.

15. The computer-implemented method of claim 11, further comprising:
determining one or more parameters of the product based on the measured distribution of the product along the surface of the dehydrator,
wherein the one or more parameters include at least one of a sheet uniformity, a sheet stability, a sheet property, a weight belt volume, a process yield, or a drum setting controllability, and
wherein the determining the differences between the distribution of the product along an inner surface of the dehydrator and the predetermined distribution of the product along the inner surface of the dehydrator, is further based on the one or more parameters.

16. The computer-implemented method of claim 11, wherein the sensor includes an image sensor configured to capture an image of the product in the dehydrator, and
wherein when measuring the distribution of the product includes accessing a captured image.

17. The computer-implemented method of claim 16, wherein when determining differences between the distribution of the product along the surface of the dehydrator and the predetermined distribution of the product along the inner surface of the dehydrator, further includes determining a metric indicating an adequacy of the distribution of the product in the dehydrator.

18. The computer-implemented method of claim 17, further comprising:
identifying, by a machine vision model, one or more locations of the product in the dehydrator based on the image; and
determining, by a machine learning model, the metric indicating an adequacy of a distribution of the product in the dehydrator based on the one or more identified locations of the product across the dehydrator.

19. The computer-implemented method of claim 11, wherein the sensor includes at least one of a pressure sensor, a flow meter, LIDAR, radar, ultrasonic sensing, a feeler gauge, or a limit switch.

20. A non-transitory computer-readable medium storing instructions for a computer-implemented method for drum dryer control in a non-contact, closed-loop system, the computer-implemented method comprising:
measuring, by a sensor, a distribution of a product along a surface of a drum dryer of the non-contact, closed-loop system;
determining differences between the distribution of the product along the surface of the drum dryer and a predetermined distribution of the product along the surface of the drum dryer; and
adjusting a control parameter of a component of the non-contact, closed-loop system in response to the determined differences to reduce the differences and control the distribution of the product along the surface of the drum dryer when the drum dryer operates.
